(19) United States
(12) Patent Application Publication
(10) Pub. No.: US 2025/0184427 A1
(43) Pub. Date: Jun. 5, 2025

(54) SYSTEM AND METHOD FOR IMPROVED AUTOMOTIVE SAFETY

(71) Applicant: JOHN F. LEONARD, Haddonfield, NJ (US)

(72) Inventor: JOHN F. LEONARD, Haddonfield, NJ (US)

(21) Appl. No.: 19/046,096

(22) Filed: Feb. 5, 2025

Related U.S. Application Data
(63) Continuation of application No. 17/895,698, filed on Aug. 25, 2022, now Pat. No. 12,256,037.
(60) Provisional application No. 63/393,328, filed on Jul. 29, 2022.

(51) Int. Cl. H04M 1/72463; B62D 1/04; H04M 1/72454; H04W 4/40; H04W 4/80

(52) U.S. Cl. CPC H04M 1/724631; B62D 1/046; H04M 1/72454; H04W 4/40; H04W 4/80

(57) ABSTRACT

A system and method for improved automotive safety, particularly aimed at the prevention of automobile, truck, and other vehicle accidents related to driving in a distracted manner while using a cell phone.

### CROSS REFERENCE TO RELATED APPLICATION

This application is a continuation of U.S. application Ser. No. 17/895,698 filed on Aug. 25, 2022, that claimed the benefit of U.S. Provisional Application No. 63/393,328 filed on Jul. 29, 2022.

### FIELD OF THE INVENTION

The general field of the instant invention is technology for the improvement of automotive safety, particularly with respect to the use by drivers distracted by their use of cell phones while driving.

### BACKGROUND OF THE INVENTION

Texting while driving is well known to cause automotive accidents, many of which end in death. For example, it has been reported that 14% of fatal car crashes involve cell phones. In 2018, over 400,000 people were injured and over 2,800 people died in distracted driving motor vehicle accidents. Tellingly, a full 42% of high school students admitted in 2015 that they text or email during driving, and statistics say that cell phone usage reduces a driver's attention by as much as 37%. (as reported by Children's Hospital of Philadelphia Research Institute) For these statistics and other examples, see:

https://www.thezebra.com/resources/research/texting-and-driving-statistics/

While law enforcement measures have been implemented in order to stem the crisis of distracted driving, the crisis continues unabated.

### SUMMARY OF THE INVENTION

Presently, the technology available is not sufficient to cure the crisis stated above, much less to prevent individual cases of distracted driving. In addition to the law enforcement efforts stated above, and while some vehicles do not allow the operator to enter navigation requests on the dashboard during driving, the technology as it currently exists does not prevent a driver from distracted driving while using his or her cell phone” vs using the hands-free feature. As another example of such limited technology, the program known as Android Auto acts simply to bring apps from a cell phone to the car display so that “you can focus while you drive.” Android promises the driver that “you can control features like navigation, maps, calls, text messages, and music.” Not only is using Android Auto solely a voluntary choice by a driver, but moreover the program requires a potential user to obtain information about that driver's car's compatibility with Android Auto by contacting the vehicle manufacturer. See generally:

https://www.android.com/auto/?gclid=Cj0KCQjwz96WBhC8ARIsAATR253-jtig-jaYbZkRHL4ibFQzbib_cwWQ2HzKe-pHjvPFeeTPI8vSYS0aAl14EALw_wcB&gclsrc=aw.ds

As described herein, the instant invention, once installed, does not provide a driver with a voluntary choice to drive undistracted; rather the instant invention prevents a driver, once installed, from accessing any application programs on a cell phone while driving as described in the preferred embodiment hereinbelow.

### BRIEF DESCRIPTION OF THE DRAWING

FIG. 1 is a flowchart of the application program that enables the method of the preferred embodiment of the present invention.

FIG. 2 is a block diagram of the system of the preferred embodiment of the present invention.

### DETAILED DESCRIPTION OF THE INVENTION

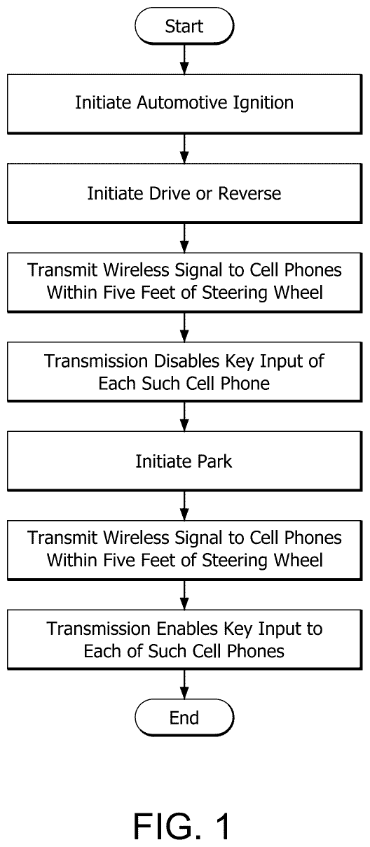

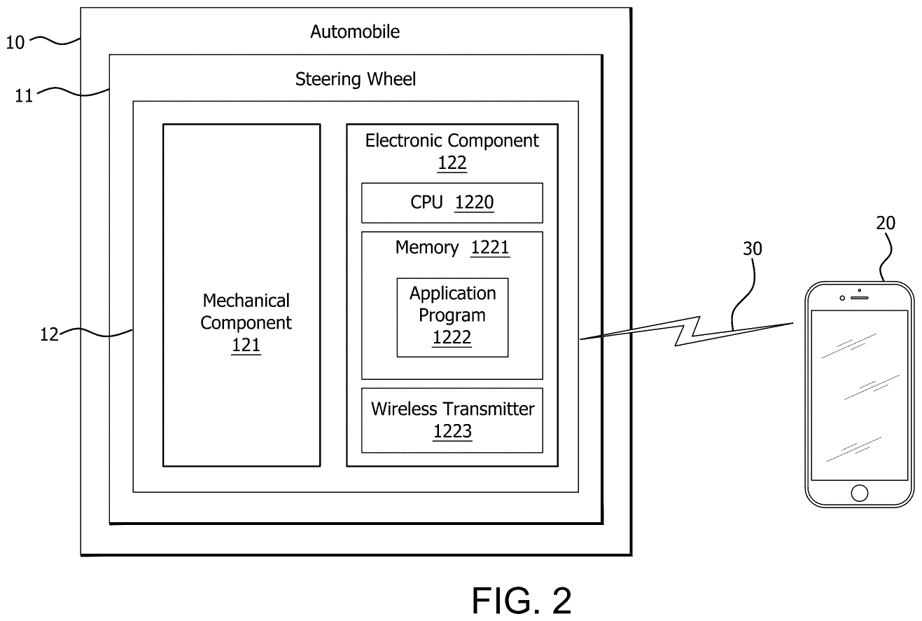

Referring to the drawings filed herewith, the flowchart of FIG. 1 sets forth the steps of the software application program 1222 of the instant invention that is shown in the block diagram of the hardware of the preferred embodiment of the disclosed system. FIG. 2 shows an automobile, truck, or bus 10, having a steering wheel 11 in which is constructed an electromechanical device 12, having a mechanical component 121 that identifies movement of vehicle 10, such as an accelerometer, and an electronic component 122 comprised of a CPU 1220, a wireless receiver/transmitter 1223, and a memory 1221 in which is stored an application program 1222. Additionally, FIG. 2 shows a cell phone 20 located within five feet of steering wheel 11 within said vehicle 10, said cell phone being in communication with said electrical component 122 through wireless connection 30. Said communication 30 can be, for example, a Bluetooth wireless link, but this is not a limitation on the breadth to be afforded this invention.

As per the flowchart of FIG. 1, when a driver starts up his or her vehicle, the mechanical component 121 of electromechanical device 12 senses motion of vehicle 10. Mechanical component 121 is outfitted to send an electronic signal to electronic component 122, which signal triggers CPU 1220 to initiate application program 1222 resident in memory 1221 of said electronic component 122. Said application program 1222 causes CPU 1220 to cause wireless transmitter 1223 to send a disabling signal via wireless link 30 to each cell phone 20 located within 5 feet of said steering wheel 11. As said flowchart shows, once PARK is initiated by the driver of vehicle 10 and mechanical component 121 senses a cessation of movement, an electronic signal is sent from said mechanical component 121 to electronic component 122, causing CPU 1220 in coordination with application program 1222 to send a wireless signal via wireless connection 30 to each cell phone 20 within five feet of steering wheel 11 cancelling the disabling signal that was previously sent to each such cell phone 20, allowing the handheld use of said cell phones 20 once again.

What is claimed is:

1. A method for preventing distracted driving of a vehicle by a driver in possession of a cell phone comprising the steps of:
initiating ignition of said vehicle,
placing said vehicle into drive mode or reverse mode;
sensing said mode,
transmitting a first wireless signal to said cell phone, and
disabling the key input function of said cell phone,
whereby said driver is unable to use the key input function of said cell phone.

2. The method of claim 1 further comprising the steps of:
placing said vehicle into park mode,
sensing said mode,
transmitting a second wireless signal to said cell phone, and
cancelling disablement of said key input function of said cell phone,
whereby said key input function of said cell phone is restored for use by said driver.

3. The method of claim 1 in which said first wireless signal is a Bluetooth signal.

4. The method of claim 2 in which said second wireless signal is a Bluetooth signal.
